(19) United States
(12) Patent Application Publication
(10) Pub. No.: US 2023/0279238 A1
(43) Pub. Date: Sep. 7, 2023

(54) CHROMIUM-FREE ANTICORROSIVE COATING COMPOSITION AND ARTICLE MADE THEREFROM

(71) Applicant: Guangdong Huarun Paints Co., Ltd., Guangdong (CN)

(72) Inventor: Tingyu HU, Guangdong (CN)

(21) Appl. No.: 18/017,687

(22) PCT Filed: Aug. 3, 2021
(86) PCT No.: PCT/CN2021/110274

§ 371 Date: Jan. 24, 2023

(30) Foreign Application Priority Data
Aug. 3, 2020 (CN) 202010767295.0

(51) Int. Cl. C09D 5/08; C09D 7/20; C09D 7/61; C09D 7/65

(52) U.S. Cl. CPC C09D 5/084; C09D 7/20; C09D 7/61; C09D 7/65; C09D 163/00

(57) ABSTRACT

The present application is directed to chromium-free anticorrosive coating composition and article made therefrom. The chromium-free anticorrosive coating composition comprises a film-forming resin composition, a lithium-containing composite metal compound, optional carriers and additional additives, wherein the lithium-containing composite metal compound has a spatially stable crystalline structure. The chromium-free anticorrosive coating composition according to the present application may be used as a primer or a direct-to-metal coating. The present application further discloses an article, comprising a metal substrate; and a coating formed of the above chromium-free anticorrosive coating composition which is directly applied to the metal substrate.

### TECHNICAL FIELD

The present application relates to an anticorrosive coating composition, and more specifically to a chromium-free anticorrosive coating composition with an excellent anticorrosive performance and an article made therefrom.

### BACKGROUND

Metal corrosion is known as a process in which a metal material is in contact with the surrounding environment and experiences a certain reaction where the material is gradually deteriorated or destroyed. Metal corrosion is a common natural phenomenon, occurring as rust on the surface of steel, white powder on the surface of aluminum products, and so on. In order to prevent metal substrates from being corroded, the substrates can be treated with anti-corrosion treatments. Such anti-corrosion treatments provide important safeguards that prolong the service life of metal substrates and ensure safety of applications.

It is recognized that hexavalent chromium compounds can provide coatings with very good anti-corrosion ability. They are not only effective over a wide range of pH, but also have self-repairing functions, and therefore are considered almost irreplaceable as anti-corrosion pigments/fillers. However, hexavalent chromium is toxic. Since the 1920s, there have been records showing that hexavalent chromium is carcinogenic in nature. Previous studies have shown that incidence of nasal cancer and lung cancer in industrial workers who are directly exposed to Cr⁶⁺ compounds has increased significantly. In view of this concern for the environment and for worker safety, the call for gradually reducing or even eliminating the application of hexavalent chromium compounds in anti-corrosion coatings has increased. In recent years, a lot of research has been conducted to look for alternative anti-corrosion pigments/fillers to replace hexavalent chromium compounds. Although many alternative reagents have been proposed, none of them have been shown to be as effective and cost-effective in anti-corrosion coating applications as hexavalent chromium compounds. The primary goal of selecting anti-corrosion pigments/fillers is to formulate coatings that meet the corrosion resistance standards of ASTMB117 salt spray test, which is a recognized aviation and aerospace industry method. In practice, some anticorrosive pigments/fillers such as aluminum tripolyphosphate cannot be formulated to meet corrosion resistance standards. Some pigments/fillers such as zinc molybdate can be formulated to meet the corrosion resistance of coatings, but are not cost-effective and are difficult to use on a large scale.

Therefore, there is need in the industry for further improvement in chromium-free anticorrosive coating compositions.ffff

### SUMMARY

The present application provides a chromium-free anticorrosive coating composition, comprising: Component A, comprising a film-forming resin composition, a lithium-containing composite metal compound, optional carriers and additional additives, wherein the lithium-containing composite metal compound has a spatially stable crystalline structure and comprises at least one transition metal element; and optionally Component B, comprising a curing agent. In some embodiments of the present application, the lithium-containing composite metal compound has a layered structure, a spinel structure, an olivine structure or a tunnel structure. Preferably, the transition metal element is one or more selected from nickel, cobalt, manganese, iron and titanium. As an exemplary illustration, the lithium-containing composite metal compound is one or more selected from the group consisting of lithium manganese oxide, lithium nickel cobalt manganese oxide, lithium cobalt oxide, and lithium iron phosphate.

The present application also provides an article comprising a metal substrate; and a coating formed of the chromium-free anticorrosive coating composition according to the present application which is directly applied to the metal substrate. Preferably, the metal substrate is one or more selected from steel, iron, aluminum, zinc, and alloys thereof.

It was surprisingly discovered the inventors of the present application that in the formulation of a chromium-free anticorrosive coating composition, lithium-containing composite metal compounds show excellent corrosion resistance. Without limiting to theory, it is believed these compounds have a spatially stable crystalline structure including but not limited to lithium manganese oxide, lithium nickel cobalt manganese oxide, lithium cobalt oxide, and lithium iron phosphate or the combination thereof, and are therefore suitable as anti-corrosion pigments/fillers. The paint film formed therefrom shows excellent corrosion resistance, which is reflected in the resulting paint film having no foaming and excellent wet adhesion following ASTM B117 salt spray test, and also has the advantage of low cost.

Without wishing to be bound by any theory, it is speculated that the chromium-free anticorrosive coating composition of the present application can achieve the aforementioned anticorrosive effect for the following reasons.

The anticorrosive coating composition of the present application comprises a lithium-containing composite metal compound, and this lithium-containing composite metal compound has a spatially stable crystal structure. In a corrosive environment, the lithium-containing composite metal compound contained in the coating formed by the above-mentioned anticorrosive coating composition can release and/or leach lithium ions therein, and the dissociated lithium ions act as a cathode inhibitor and react with oxygen, water, and the like in the environment to form a passivation layer so that it may protect a metal substrate from external corrosion. On the other hand, the lattice structure of the lithium-containing composite metal compound is basically stable and will not collapse, so that the paint film will not lose its adhesion while keeping a certain strength. Therefore, the coating composition formulated from the lithium-containing composite metal compound can achieve excellent anticorrosion performance, and the above-mentioned lithium-containing composite metal compound, such as lithium manganese oxide, has the advantage of low cost. That is to say, the coating composition formulated therefrom is cost-effective while maintaining an excellent anti-corrosion performance, and is suitable for widespread application.

The details of one or more embodiments of the present disclosure are set forth in the description below. Other features, objects, and advantages of the present disclosure will be apparent from the description, and from the claims.

### DESCRIPTION FOR DRAWINGS

FIG. 1 shows photographs of coatings comprising a primer layer (an upper gray coating) formed by the epoxy-based chromium-free anticorrosive coating composition according to Examples 1-3 of the present application and a composite coating (a lower yellow coating) formed by coating the above primer with a water-based polyurethane topcoat after undergoing the ASTM B117 salt spray resistance test for 799 hours, 792 hours and 792 hours, respectively.

FIG. 2 shows a coating cross-sectional view obtained by peeling a composite coating off a substrate and analyzing it by scanning electron microscopy (SEM), in which the top half of the picture is the topcoat layer, and the bottom half of the picture is the primer layer, wherein the composite coating consists of a primer layer formed by the epoxy-based chromium-free anticorrosive coating composition according to Example 2 of the present application and a water-based polyurethane topcoat that is applied on the primer layer and is subjected to the ASTM B117 salt spray resistance test for 792 hours.

FIG. 3 shows photographs of primer layers after subjecting to retort in hot water at 80° C. with 5 wt % sodium chloride for 64 hours in which the primer layers are those formed by a polyaspartate-based chromium-free anticorrosive coating composition according to Example 5 of the present application and those formed by a polyaspartate-based coating composition free of lithium-containing composite metal compounds (Comparative Example 5).

FIG. 4 shows photographs of coatings after undergoing the ASTM B117 salt spray resistance test for 800 hours in which the coatings are those (right) formed by the chromium-free anticorrosive coating composition containing lithium manganese oxide according to Example 2 of the present application and a water-based polyurethane topcoat and those (middle) formed by the anticorrosive coating composition containing aluminum tripolyphosphate according to Comparative Example 2 and the same water-based polyurethane topcoat in a wet-to-wet manner and those (left) formed by the coating composition containing lithium carbonate according to Comparative Example 4 and the same water-based polyurethane topcoat in a wet-to-wet manner.

FIG. 5 shows the peeling width of the coatings formed by the coating compositions of Comparative Examples 1-3 and Examples 1-4 shown in the Examples section after undergoing 600 hours and 800 hours of the ASTM B117 salt spray resistance test, respectively and the cost for each coating compositions.

### DEFINITION

As used herein, “a”, “an”, “the”, “at least one”, and “one or more” are used interchangeably. Thus, for example, a composition that comprises “an” additive can be interpreted to mean that the composition includes “one or more” additives.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the present disclosure, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The term “anticorrosive coating composition” refers to a coating composition that, when applied to a metal substrate in one or more layers, can form a coating layer that can be exposed to corrosive conditions over a relatively long period, for example, salt spray exposure for three weeks or more without obvious visible deterioration or corrosion.

When used for “chromium-free anticorrosive coating composition”, the term “chromium-free” means that various components of the coating composition and the formulated coating composition do not contain any additional hexavalent chromium ions, preferably do not contain any chromium compounds. When the phrases “does not contain”, “does not contain any”, and so on are used herein, such phrases are not intended to exclude the presence of trace related structures or compounds that may exist as environmental pollutants or due to environmental pollution.

When used for “chromium-free anticorrosive coating composition”, the term “lithium-containing composite metal compound” refers to a compound formed from metallic lithium and one or more other metals, which may be an oxide or an oxo acid salt. In the present application, the “lithium-containing composite metal compound” contains at least one transition metal element in addition to lithium. In some embodiments of the present application, the transition metal element is one or more selected from nickel, cobalt, manganese, iron and titanium.

When used for “lithium-containing composite metal compound”, the phrase “having releasable and/or leachable lithium ions” means that under corrosive conditions, such as 5 wt % aqueous sodium chloride spray at 35° C. or higher, lithium in the lithium-containing composite metal compound can be dissociated into lithium ions.

When used for “lithium-containing composite metal compounds”, the phrase “having a spatially stable crystal structure” means that the compound has structural stability, namely a crystal structure that is conducive to intercalation into and deintercalation out of lithium ions (abbreviated as “intercalation-deintercalation”), and where the crystal structure remains basically stable during the intercalation-deintercalation of lithium ions without major lattice changes. When the coating formed by the coating composition containing the lithium-containing composite metal compound is under certain conditions, especially under corrosive conditions (for example, 5 wt % sodium chloride aqueous spray at 35° C. for 600 hours or longer), the lithium-containing composite metal compound in the coating maintains a spatially stable three-dimensional structure after the dissociation of lithium ions, and the coating does not appear to collapse, develop voids, and the like. The phenomenon of “collapse, voids and the like” on the surface of coating described here is measured by scanning electron microscope (SEM). The “spatially stable crystal structure”, as an example, may be a layered structure, a spinel structure, an olivine structure, or a tunnel structure.

When used for “chromium-free anticorrosive coating composition”, the term “film-forming resin composition” refers to a component that may form a non-sticky (i.e. dry or hardened) continuous film on the substrate after it is mixed with other components in the coating composition (such as carriers, additives, fillers, and the like), and the resulting mixture is applied to the substrate and dried, cross-linked or otherwise hardened together with a suitable curing agent as required. The “film-forming resin composition” mainly consists of a resin component.

When used herein, the term “primer” refers to a coating composition that can be applied to a metal substrate and dried, crosslinked, or otherwise hardened to form a non-sticky continuous film having sufficient adhesion to the surface of substrate.

As used herein, the term “direct-to-metal coating (DTM)” refers to a coating composition that can be applied to a metal substrate and dried, crosslinked, or otherwise hardened to form a non-sticky continuous film that has sufficient adhesion on the surface of substrate, and can withstand long-term outdoor exposure without showing visible and unsatisfactory deterioration. The direct-to-metal coating (DTM) not only functions as a primer, having strong adhesion and corrosion resistance, but also as a topcoat, showing a good appearance and decorative effect. Compared to the process of applying primer and topcoat separately, the direct-to-metal coating (DTM) can reduce construction costs and time.

The term “comprises”, “comprising”, “contains” and variations thereof do not have a limiting meaning where these terms appear in the description and claims.

The terms “preferred” and “preferably” refer to embodiments of the present disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

### DETAILED DESCRIPTION

The present application in one aspect provides a chromium-free anticorrosive coating composition, comprising Component A, comprising a film-forming resin composition, a lithium-containing composite metal compound, optional carriers and additional additives, wherein the lithium-containing composite metal compound has a spatially stable crystalline structure and comprises at least one transition metal element; and optionally Component B, comprising a curing agent.

In embodiments according to the present application, the chromium-free anticorrosive coating composition comprises a lithium-containing composite metal compound. As mentioned above, the lithium-containing composite metal compound is a compound formed from a lithium element and one or more other metal elements, and may be an oxide or an oxo acid salt. The “lithium-containing composite metal compound” comprises at least one transition metal element, such as cobalt, nickel, manganese, iron, titanium, or a combination thereof. Moreover, the lithium-containing composite metal compound has a spatially stable crystal structure, which structure remains basically stable in case of intercalation-deintercalation.

Composite metal compounds, especially lithium-containing composite metal compounds are not the common component of coating compositions in the coating industry. However, it was surprisingly found by the inventors of the present application that lithium-containing composite metal compounds having a spatially stable crystal structure are particularly suitable as an anti-corrosion or anti-rust pigment/filler, and the paint film formed therefrom will not blister after the ASTM B117 salt spray test, has excellent wet adhesion, and is low in cost.

It is well known that the above-mentioned lithium-containing composite metal compounds can be used as cathode materials in the field of lithium-ion batteries. Prior to the present application, there is no prior disclosure and teaching that the lithium-containing composite metal compound can be used as an anticorrosive pigment/filler of an anticorrosive coating composition. The above findings of the inventors of the present application were unforeseeable prior to the present application. Without being bound by any theory, the applicant believes that in a corrosive environment, for example, 5 wt % sodium chloride aqueous spray at 35° C. for 600 hours or more, the lithium-containing composite metal compound contained in the coating formed from the above-mentioned anticorrosive coating composition can release and/or leach lithium ions therein, and the dissociated lithium ions act as a cathode inhibitor and react with oxygen, water, and the like in the environment to form a passivation layer that may protect a metal substrate from external corrosion. On the other hand, the lattice structure of the lithium-containing composite metal compound is basically stable in the process of dissociation of lithium ions and will not collapse, so that the paint film will not lose its adhesion while keeping a certain strength, thereby achieving an anti-corrosion effect.

In some embodiments of the present application, the lithium-containing composite metal compound may have a layered structure, a spinel structure, an olivine structure, or a tunnel structure.

In some embodiments of the present application, the lithium-containing composite metal compound is one or more selected from the group consisting of lithium manganese oxide, lithium nickel cobalt manganese oxide, lithium cobalt oxide, and lithium iron phosphate.

In some embodiments of the present application, the lithium-containing composite metal compound may further include one or more other metal salts, preferably magnesium salts. Suitable examples include, without limitation, magnesium oxide, oxyaminophosphate salts of magnesium, magnesium carbonate, magnesium hydroxide, and mixtures or combinations thereof. These magnesium compounds would be added as corrosion inhibitors with the lithium-containing composite metal compounds.

In some embodiments of the present application, the lithium-containing composite metal compound is basic and has a pH of at least 8.0. Preferably, the pH of the lithium-containing composite metal compound is in the range of 8.0 to 11.5, more preferably, in the range of 8.5 to 11.2. In one embodiment of the present application, the pH of the lithium-containing composite metal compound is in the range of 8.5 to 9.0. In another embodiment of the present application, the pH of the lithium-containing composite metal compound is in the range of 9.5 to 11.2.

The above-mentioned lithium-containing composite metal compound may be any known commercially available product. Exemplary commercially available lithium-containing composite metal compounds include, without limitation, lithium manganese oxide commercially available from Dameng of CITIC, lithium nickel manganese cobalt oxide commercially available from Dameng of CITIC, and lithium nickel manganese cobalt oxide commercially available from Rongbai, or combinations thereof.

Preferably, the anticorrosive coating composition comprises about 3% to about 15% by weight of the lithium-containing composite metal compound relative to the total weight of Component A. The inventors of the present application found that the lithium-containing composite metal compound had excellent anti-corrosion performance, and an acceptable anti-corrosion effect in an amount of only 10% by weight or less relative to the total weight of Component A. Preferably, relative to the total weight of Component A, 9% by weight or less of the above-mentioned lithium-containing composite metal compound can achieve an acceptable anticorrosive effect. In a specific embodiment of the present application, the anticorrosive coating composition comprises, relative to the total weight of Component A, about 4 to 14% by weight of lithium-containing composite metal compound, or about 5 to 13% by weight of lithium-containing composite metal compound, or about 5 to 12% by weight of the lithium-containing composite metal compound, or about 5 to 11% by weight of the lithium-containing composite metal compound, or about 5 to 10% by weight of the lithium-containing composite metal compound.

In some embodiments according to the present application, the chromium-free anticorrosive coating composition is a two-component coating composition comprising component A and component B, where component A comprises a film-forming resin composition, a lithium-containing composite metal compound, optional carriers and additional additives and component B comprises a curing agent. Prior to use, Component A and Component B are mixed for application.

In some other embodiments according to the present application, the chromium-free anticorrosive coating composition is a one-component coating composition comprising Component A, where Component A comprises a film-forming resin composition, a lithium-containing composite metal compound, optional carriers and additional additives. In these embodiments, the film-forming resin composition may be cured into a film by means such as self-crosslinking.

The film-forming resin composition refers to a composition that constitutes the main body of a coating formed from a chromium-free anticorrosive coating composition, and comprises a resin component.

In some embodiments according to the present application, the resin component may be at least one selected from epoxy resins, chlorinated resins, polyaspartates, alkyd resins, phenolic resins, polyurethanes, polysiloxanes, polyesters, and acrylics resin. In a currently preferred embodiment, the resin component may be at least one of selected from epoxy resin, polyurethane and polyaspartate. In a currently more preferred embodiment, the resin component may be at least one selected from epoxy resin and polyaspartate.

In a preferred embodiment according to the present application, the resin component is epoxy resin. The term “epoxy resin” as used herein refers to a polymer or oligomer containing two or more epoxy groups in one molecule. Preferably, the epoxy resin contains at most four epoxy groups in one molecule. More preferably, the epoxy resin contains two or three epoxy groups in one molecule. According to some embodiments of the present invention, the epoxy resin may have an epoxy equivalent varying over a wide range, wherein the epoxy equivalent is the mass of an epoxy resin containing 1 mole of epoxy group. For example, the epoxy resin may comprise a low epoxy equivalent epoxy resin, a high epoxy equivalent epoxy resin or its combination thereof. As used herein, the epoxy resin having an epoxy equivalent between 400 and 700 g/eq, preferably between 450 and 550 g/eq is known as a low epoxy equivalent epoxy resin. The epoxy resin having a higher epoxy equivalent, such as having an epoxy equivalent greater than 800 g/eq, is known as a high epoxy equivalent epoxy resin. Preferably, the high epoxy equivalent epoxy resin may have an epoxy equivalent in the range of 900 g/eq to 2500 g/eq. In some embodiments, the high epoxy equivalent epoxy resin may have an epoxy equivalent in the range of 850 g/eq to 1200 g/eq. In some embodiments, the high epoxy equivalent epoxy resin may have an epoxy equivalent in the range of 1400 g/eq to 2500 g/eq, for example, in the range of 1600 to 1800 g/eq, or in the range of 1700 to 2200 g/eq.

Suitable epoxy resin comprises, for example diglycidyl ether of polyhydric phenol, such as diglycidyl ether of resorcinol, diglycidyl ether of catechol, diglycidyl ether of hydroquinone, diglycidyl ether of bisphenol A, diglycidyl ether of bisphenol F, diglycidyl ether of bisphenol S, diglycidyl ether of tetramethyl bisphenol; diglycidyl ether of polyalcohol, such as diglycidyl ether of aliphatic diglycol and diglycidyl ether of polyether glycol, for example diglycidyl ether of C2-24 alkylene glycol, diglycidyl ether of poly(ethylene oxide) glycol or diglycidyl ether of poly(propylene oxide) glycol; or polyglycidyl ether of novolack resin, such as polyglycidyl ether of phenol-formaldehyde resin, polyglycidyl ether of alkyl substituted phenol-formaldehyde resin, polyglycidyl ether of phenol-hydroxyl benzaldehyde resin, or polyglycidyl ether of cresol-hydroxyl benzaldehyde resin; or the combination thereof.

According to some embodiments of the present disclosure, the epoxy resin is diglycidyl ether of polyhydric phenol, especially preferably having the structure of formula (I).

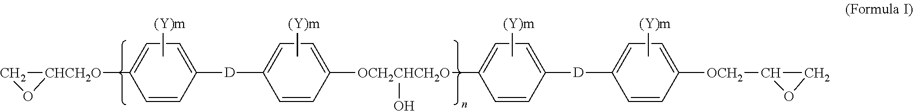

wherein
D each represents —S—, —S—S—, —SO—, —SO₂—, —CO₂—, —CO—, —O— or C₁ to C₁₀ alkylene, preferably C₁ to C₅ alkylene, more preferably C₁ to C₃ alkylene, such as —CH₂— or —C(CH₃)₂—,
Y each independently represents halogen, such as F, Cl, Br, or I, or optionally substituted monovalent C₁ to C₁₀ hydrocarbon group, such as optionally substituted methyl, ethyl, vinyl, propyl, allyl or butyl;
m each independently represents 0, 1, 2, 3 or 4, and
n represents an integer from 0 to 4, such as 0, 1, 2, 3 or 4.

More preferably, the epoxy resin is bisphenol A epoxy resin, bisphenol S epoxy resin or bisphenol F epoxy resin having the structure of formula (I) in which D represents —C(CH₃)₂—, —SO₂— or —CH₂— respectively, m represents 0, and n represents an integer from 0 to 4.

Most preferably, the epoxy resin is bisphenol A epoxy resin having the structure of formula (I) in which D represents —C(CH₃)₂—, m represents 0, and n represents an integer from 0 to 4.

The epoxy resin as disclosed herein may be prepared by the epichlorohydrin technology which is well-known by those skilled in the art, for example. Alternatively, as an example of epoxy resin, any suitable commercial product may be used, for example E55, E51, E44, or E20 available from Kaiping Resin Company, Shanghai, China; or those in the form of an aqueous epoxy resin emulsion, such as Allnex 387 from Allnex, 3907 from Huntsman, 900 and 1600 from Nanya, or EPIKOTE™ Resin 6520 from Hexion. Preferably, the aqueous epoxy resin emulsion has a solid content of 40-60 wt %.

In another preferred embodiment according to the present application, the resin component is polyaspartate. Polyaspartate is a component known to those skilled in the art, which is a polyamine having secondary amino groups (for example, 2 secondary amino groups).

Preferably, the polyaspartate ha a number average molecular weight of preferably in the range of between 500 g/mol and 1200 g/mol, for example between 550 g/mol and 900 g/mol. The molecular weight can be measured by GPC according to ISO 13885-1:2008. Preferably, the polyaspartate may have an amine equivalent of between 150 g/eq and 450 g/eq, such as 200-350 g/eq. The amine equivalent is calculated from the amine value according to the following formula: amine equivalent=56.1×1000/[amine value], where the amine value can be determined according to ASTM D2074.4.

As an exemplary illustration, the polyaspartate has the structure shown in the following general formula (1) as described in U.S. Pat. No. 5,126,170:

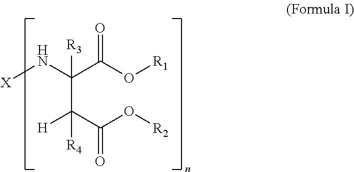

wherein X represents an alicyclic hydrocarbon that is inert to isocyanate groups at a temperatures of 100° C. or less; R1 and R2 each independently represent organic groups that are inert to isocyanate groups at a temperature of 100° C. or less; R3 and R4 each independently represent hydrogen and organic groups that are inert to isocyanate groups at a temperature of 100° C. or less; and n is an integer of at least 2.

For example, X may be an alicyclic hydrocarbon containing 6 to 20 carbon atoms. Preferably, X represents a divalent hydrocarbon group obtained by removing amino groups from: 1,4-diaminobutane, 1,6-diaminohexane, 2,2,4- and 2,4,4-trimethyl-1,6-diaminohexane, 1-amino-3,3,5-trimethyl-5-aminomethyl-cyclohexane, 4,4′-diamino-dicyclohexylmethane or 3,3-dimethyl-4,4′-diamino-dicyclohexylmethane.

Preferably, n is 2.

Preferably, R₁ and R₂ represent C₁-C₆ alkyl, such as methyl or ethyl. Preferably, R3 and R₄ represent hydrogen.

As described in U.S. Pat. No. 5,126,170, polyaspartate amines can be prepared by reacting one or more cyclic polyamines containing primary amine groups with unsaturated dialkyl esters.

The cyclic polyamine component containing more than one primary amine group used for the production of polyaspartate usually contains 6 to 25 carbon atoms and contains at least one alicyclic ring. Examples of suitable cycloaliphatic diamine components comprise 1,3-diaminocyclohexane, 1,4-diaminocyclohexane, 1,6-diaminocyclohexane, 2,2,4- and 2,4,4-trimethyl-1,6-diaminohexane, 1-amino-3,3,5-trimethyl-5-aminomethylhexane and preferably bis(aminomethyl)cyclohexane including 1,3-bis(aminomethyl)cyclohexane, 1,4-bis(aminomethyl)cyclohexane, isophorone diamine, bis(4-aminocyclohexyl)methane, bis(4-aminocyclohexyl)propane, 4,4-diamino-3,3-dimethyldicyclohexylmethane, 4,4-diamino-3,3-dimethyldicyclohexylpropane, 4,4-diamino-3,3-dimethyl-5,5-dimethyldicyclohexylmethane, 4,4-diamino-3,3-dimethyl-5,5-dimethyldicyclohexylpropane.

The unsaturated dialkyl ester used in the production of polyaspartate is preferably an ester of butenedioic acid, such as an ester of maleic acid or fumaric acid, for example, dimethyl, diethyl, dipropyl and di-n-butyl ester of maleic acid and fumaric acid.

The polyaspartate as disclosed above can be prepared, for example, by techniques well known to those skilled in the art. As an example of polyaspartate, any conventional polyaspartate can be used, such as Desmophen® NH series products available from Bayer MaterialScience AG (Leverkusen, Germany).

According to the present application, the above mentioned resin component is used for providing a film-forming resin composition for the chromium-free anti-corrosive coating composition. In one aspect, the resin component functions as a binder which provides adhesion to a substrate, and holds together other components, such as fillers, of the coating composition to impart basic cohesive strength to the paint film forming from the coating composition of the present disclosure. In the other aspect, the resin component has good reactivity with a curing agent, thereby providing a coating having high mechanical strength.

Preferably, the chromium-free anticorrosive coating composition comprises about 30% to about 70% by weight of the film-forming resin composition relative to the total weight of Component A. In some embodiments of the present application, the chromium-free anticorrosive coating composition comprises at least about 32% by weight, or at least about 34% by weight, or at least about 40% by weight, or at least about 45% by weight of the film-forming resin composition relative to the total weight of the Component A. In the above embodiment of the present application, the chromium-free anticorrosive coating composition comprises less than about 65% by weight, or less than about 60% by weight, or less than about 55% by weight of the film-forming resin composition relative to the total weight of the Component A.

If required, the chromium-free anticorrosive coating composition further comprises a curing agent for the resin component, the type of which depends on the nature of the resin component.

The epoxy resin-containing coating composition preferably comprises an aliphatic or aromatic amine curing agent, a polyamide curing agent, or a mercaptan-based curing agent. Suitable amine curing agents are aliphatic amines and their adducts (e.g. ANCAMINE 2021), phenalkamines, cycloalicyclic amines (e.g. ANCAMINE 2196), amidoamines (e.g. ANCAMIDE 2426), polyamides and their adducts, and their mixtures.

The coating composition containing amino and/or hydroxyl functional resin preferably adopts isocyanate and isocyanurate as curing agents. Suitable isocyanate curing agents are aliphatic, cycloaliphatic and aromatic polyisocyanates, such as trimethylene diisocyanate, 1,2-propylene diisocyanate, tetramethylene diisocyanate, 2,3-butylene diisocyanate, hexamethylene diisocyanate, octamethylene diisocyanate, 2,4-trimethylhexamethylene diisocyanate, 2,4,4-trimethylhexamethylene diisocyanate, dodecamethylene diisocyanate, 1,3-cyclopentylidene diisocyanate, 1,2-cyclohexylidene diisocyanate, 1,4-cyclohexylidene diisocyanate, 4-methyl-1,3-cyclohexylidene diisocyanate, meta- and p-phenylene diisocyanate, 1,3- and 1,4-bis(isocyanate methyl)benzene, 1,5-dimethyl-2,4-bis(isocyanate methyl)benzene, 1,3,5-triisocyanatebenzene, 2,4-toluene diisocyanate, 2,6-toluene diisocyanate, 2,4,6-toluene triisocyanate, α,α,α′,α′-tetramethyl o-, m- and p-xylylene diisocyanate, 4,4′-diphenylene diisocyanate methane, 4,4′-diphenylene diisocyanate, 3,3′-dichloro-4,4′-diphenylene diisocyanate, naphthalene-1,5-diisocyanate, isophorone diisocyanate, trans-vinylidene diisocyanate, and mixtures of the above-mentioned polyisocyanates. Adducts of the aforementioned polyisocyanates are also suitable, such as biuret, isocyanurate, allophonate, uretdione and mixtures thereof. Depending on the application, the above-mentioned isocyanates and their adducts may exist in the form of blocked or latent isocyanates.

In the two-component chromium-free anticorrosive coating composition according to the present application, the amount of curing agent used as Component B can be adjusted empirically by those skilled in the part based on the amount of component A, especially the amount of film-forming resin composition in component A. In some embodiments of the present application, the weight ratio of Component A and Component B as the curing agent may be 100:15, 100:23 or other commonly used ratios of Component A and Component B in the art.

In embodiments according to the present application, the carrier is optional in the formulation of the chromium-free anticorrosive coating composition. In some embodiments according to the present application, the chromium-free anticorrosive coating composition does not contain a carrier and is present in the form of a powder coating composition. In some embodiments according to the present application, the chromium-free anticorrosive coating composition may include a carrier and is present in the form of a solvent-borne coating composition or an aqueous coating composition.

If present, the carrier comprises water, a water-miscible organic solvent, a water-immiscible organic solvent, or a combination thereof, thereby reducing the viscosity of the coating composition for application. The addition of organic solvents can increase the volatilization rate of the anticorrosive coating composition and accelerate the formation of the paint film. In some embodiments of the present application, the organic solvent includes ketones (such as acetone, methyl isopropyl ketone, methyl isobutyl ketone, and the like), alcohols (propanol, benzyl alcohol, and the like), esters (ethyl acetate, butyl acetate, and the like), aromatic hydrocarbons (toluene, xylene, and the like), aliphatic hydrocarbons (cyclopentane, cyclohexane, and the like) or any combination thereof.

In a preferred embodiment according to the present application, if present, the carrier may, for example, account for at least about 5 wt %, at least about 6 wt %, at least about 7 wt %, at least about 8 wt %, at least about 9 wt %, or at least about 10 wt % of the total weight of Component A. In a preferred embodiment according to the present application, if present, the carrier may, for example, account for at most about 15 wt %, at most about 14 wt %, at most about 13 wt %, or at most about 12 wt % of the total weight of Component A. Generally, the desired amount of the carrier is usually selected empirically based on the film-forming properties of the paint film.

In embodiments of the present application, the chromium-free anticorrosive coating composition may optionally further include commonly used additional additives. Suitable additional additives may include fillers, wetting and dispersing agents, defoamers, leveling agents, additional corrosion inhibitors, adhesion promoters, film forming aids, rheology modifiers, or any combination thereof.

The content of each of the above-mentioned optional ingredients is sufficient to achieve its intended purpose, but preferably, such content does not adversely affect the coating composition or the coating obtained therefrom. According to certain embodiments of the present application, the total amount of additional additives is in the range of about 0% to about 65% by weight, preferably in the range of about 0.1% to about 60% by weight relative to the total weight of Component A.

In a specific embodiment according to the present application, Component A of the chromium-free anticorrosive coating composition comprises, relative to the total weight of component A,

30-70% by weight of the film-forming resin composition;
3-15% by weight of lithium-containing composite metal compound;
0-15% by weight, preferably 5-12% by weight of the carrier; and
0-65% by weight of the additional additives, preferably 0.1-60% by weight of the additional additives.

The anticorrosive coating composition of the present application can be prepared by any suitable mixing method known to those of ordinary skill in the art. For example, the coating composition can be made by adding the film-forming resin composition, the lithium-containing composite metal compound, the carrier (if any) and the additional additives (if any) to a container, and then stirring the resulting mixture uniformly, thereby forming the Component A. According to requirements, the curing agent as component B may exist as a single component or may be mixed with the above-mentioned components in the form of a mixture.

The chromium-free anticorrosive coating composition thus formed can be used as a primer in combination with a conventional topcoat, or can be used alone as a direct-to-metal coating composition to provide metal substrates with required anticorrosive properties. In some embodiments according to the present application, the chromium-free anticorrosive coating composition is a primer. In some embodiments according to the present application, the chromium-free anticorrosive coating composition is a direct-to-metal coating.

As described above, the inventors of the present application surprisingly discovered that the anticorrosive coating composition prepared can achieve excellent anticorrosive performance when used as a primer or as a direct-to-metal coating.

In an embodiment according to the present application, when the above-mentioned coating composition is used as a direct-to-metal coating and applied to a sandblasted steel plate in a dry paint film thickness of 40 to 70 microns and cured, and the resulting paint film is scratched to form cross-shaped scratches so as to obtain a test sample, the test sample after salt spray testing according to ASTM B117 for 600 hours or longer, does not blister.

In an embodiment according to the present application, when the above-mentioned coating composition is used as a direct-to-metal coating and applied to a sandblasted steel plate in a dry paint film thickness of 45 to 50 microns and cured, and the resulting paint film is scratched to form cross-shaped scratches so as to obtain a test sample, the test sample after salt spray testing according to ASTM B117 for 600 hours or longer, has a stripping width of 2 mm or less.

It was further surprisingly found by the inventors of the present application that using a wet-to-dry process or a wet-to-wet process, the combination of the anticorrosive coating composition prepared as above as a primer with a conventional topcoat (such as a water-based polyurethane topcoat) shows excellent anti-corrosion performance, which is unexpected. As an exemplary illustration, the wet-on-wet process includes, for example, the following steps: applying a primer, leveling it at room temperature for 15 minutes, spraying a topcoat, leveling it for more than 20 minutes, and then curing the coating at 60° C. for 30 minutes. As an exemplary illustration, the wet-to-dry process includes, for example, the following steps: applying a primer, leveling it at room temperature for 15 minutes, curing it at 80° C. for 30 minutes, and then spraying a topcoat, leveling it for more than 20 minutes, and then curing it at 60° C. 30 minutes.

In an embodiment according to the present application, when using a wet-to-dry process, the above-mentioned coating composition is used as a primer and applied to a sandblasted steel plate in a dry paint film thickness of 45 to 70 microns and cured, and a polyurethane topcoat is applied to the dried primer in a dry paint film thickness of 45 to 70 microns and cured, and the resulting paint film is scratched to form cross-shaped scratches so as to obtain a test sample, the test sample after subjecting to a salt spray test according to ASTM B117 for 600 hours or longer, has a stripping width (also known as creep from scribe) of 2 mm or less.

In an embodiment according to the present application, when using a wet-to-wet process, the above-mentioned coating composition is used as a primer and applied to a sandblasted steel plate in a dry paint film thickness of 45 to 70 microns, and a polyurethane topcoat is applied to the wet primer in a dry paint film thickness of 45 to 70 microns and cured, and the resulting paint film is scratched to form cross-shaped scratches so as to obtain a test sample, the test sample after subjecting to a salt spray test according to ASTM B117 for 600 hours or longer, has a stripping width of 2 mm or less.

In another aspect, the present application provides an article comprising a metal substrate; and a coating formed of the chromium-free anticorrosive coating composition according to the present application which is directly applied to the metal substrate. As mentioned above, the chromium-free anticorrosive coating composition of the present application can be used as a primer or as a direct-to-metal coating. Therefore, in some embodiments of the present application, the article comprises a metal substrate; a primer layer formed of the chromium-free anticorrosive coating composition of the present application, which is directly coated on the metal substrate; and a topcoat formed from a conventional topcoat in the art (for example, a water-based polyurethane topcoat) applied over the primer. In other embodiments of the present application, the article comprises a metal substrate; and a coating formed of the chromium-free anticorrosive coating composition of the present application, which is directly coated on the metal substrate

As a metal substrate for manufacturing the article of the present invention, any suitable metal substrate known in the art can be used. As an example, the metal substrate is one or more selected from steel, iron, aluminum, zinc and their alloys.

According to the present invention, the article can be prepared, for example, by the following steps: (1) providing a polished metal substrate; (2) using a coating and curing process to sequentially coat and form one or more chromium-free anticorrosive coating composition of the present invention on the metal substrate to provide corrosion resistance for the metal substrate.

According to the present invention, the metal articles thus obtained can be further treated with an additional anticorrosive topcoat, and can be used for the following end-use applications, including but not limited to refrigerated containers and unrefrigerated shipping containers (e.g., dry cargo containers) from suppliers or manufacturers including China International Marine Containers (CTMC), Graaff Transportsysteme Gmbh, Maersk Line and others that will be familiar to persons having ordinary skill in the art, chassis, trailers including semitrailers, rail cars, truck bodies, ships, bridges, building skeletons, and other prefabricated or site-fabricated metal articles needing temporary indoor or outdoor corrosion inhibition during fabrication. Additional uses include metal angles, channels, beams (e.g., I-beams), pipes, tubes, plates and other components that may be welded into these and other metal articles, and the like.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### EXAMPLES

Test Methods

Blistering

According to needs, the anticorrosive coating composition was used as a primer or as a direct-to-metal coating and applied to a sandblasted steel plate in a dry paint film thickness of 45 to 70 microns and cured to form a test sample. Where the anticorrosive coating composition was used as a primer, the test sample also had a commercially available waterborne polyurethane (WKY0305, from Valspar Corporation) topcoat applied over the primer in a dry paint film thickness of 40 to 70 microns.

Then, the obtained test sample was subjected to salt spray testing according to ASTM B117 for a specific period of time, and the coating surface was visually observed for blistering. The ASTMB117 salt spray test is a standardized method for determining the corrosion resistance of coatings applied to metal surfaces. This test was carried out in a salt spray box, in which a salt solution (usually a 5% NaCl aqueous solution, with a neutral pH) was atomized and then sprayed on the surface of a sandblasted steel plate with a coating in a dry film thickness of 45 to 70 microns (μm) dry film thickness.

When the coating blistered after the 600-hour salt spray test, the test sample was considered unqualified, i.e. the coating failed. When the coating did not blister after the 600-hour salt spray test, the test sample was considered qualified, i.e. the coating passed.

### Wet Adhesion

According to needs, the anticorrosive coating composition was used as a primer or as a direct-to-metal coating and applied to a sandblasted steel plate in a dry paint film thickness of 40 to 70 microns and cured to form a test sample. Where the anticorrosive coating composition was used as a primer, the test sample also had a commercially available waterborne polyurethane (WKY0305, from Valspar Corporation) topcoat applied over the primer in a dry paint film thickness of 40 to 70 microns.

Then, the obtained test sample was subjected to a salt spray test according to ASTM B117 for 600 hours or more, and the stripping width of scratches was measured. When the stripping width after 600 hours of salt spray test exceeded 2 mm, the test sample was considered unqualified and had poor wet adhesion. When the stripping width after the 600-hour salt spray test was 2 mm or less, the test sample was considered to be qualified (i.e. the coating passed) and had excellent wet adhesion.

### Starting Materials

TABLE 1

| Starting Materials | Supplier |
|---|---|
| Epoxy resin | HEXION, 6529 |
| Epoxy resin curing agent-1 | HUNTSMAN, 3986 |
| Epoxy resin curing agent-2 | HEXION, 6870 |
| Polyaspartate | Self-made |
| Polyaspartate curing agent | Covestro, 3600 |
| Strontium Chromate | Sambo |
| Aluminum tripolyphosphate | HEUBACH |
| Zinc molybdate | Shenlong Zinc Industry |
| Lithium Nickel Manganese | Dameng of CITIC |
| Cobalt Oxide | |
| Lithium manganese oxide | Dameng of CITIC |
| Waterborne polyurethane | WKY0305 from Valspar Corp. |
| topcoat | |

### Epoxy Resin-Based Anticorrosive Coating Composition

As shown in Table 2, the components of component A were mixed to obtain a mixture, which was then mixed with the curing agent as Component B to form the epoxy resin-based anticorrosive coating composition according to Examples 1 to 4 (Ex. 1-4) of the present application and Comparative Examples 1 to 4 (CEx. 1-4), wherein Comparative Example 1 was a chromium-containing epoxy-based anticorrosive coating composition, Comparative Example 2 was a chromium-free epoxy-based anticorrosive coating composition containing aluminum tripolyphosphate; Comparative Example 3 was a chromium-free epoxy-based anticorrosive coating composition containing zinc molybdate; Comparative Example 4 was a chromium-free epoxy-based anticorrosive coating composition containing lithium carbonate; and Examples 1 to 4 were epoxy-based anticorrosive coating composition comprising NMC, lithium manganese oxide, a 1:1 mixture of NMC and lithium manganese oxide, and a 2:5 mixture of lithium molybdate and lithium manganese oxide, respectively.

TABLE 2
Composition and amount of epoxy resin-based anticorrosive coating composition

| Raw materials/g | CEx. 1 | CEx. 2 | CEx. 3 | CEx. 4 | Ex. 1 | Ex. 2 | Ex. 3 | Ex. 4 |
|---|---|---|---|---|---|---|---|---|
| Component A | | | | | | | | |
| Epoxy resin | 45 | 45 | 45 | 45 | 45 | 45 | 45 | 45 |
| Strontium Chromate | 6 | — | — | — | — | — | — | — |
| Aluminum tripolyphosphate | — | 6 | — | — | — | — | — | — |
| Zinc molybdate | — | — | 6 | — | — | — | — | 2 |
| Lithium Carbonate | | | — | 6 | — | — | — | — |
| Lithium Nickel Manganese | — | — | — | — | 6 | — | 3 | — |
| Cobalt Oxide | | | | | | | | |
| Lithium manganese oxide | — | — | — | — | — | 6 | 3 | 5 |
| Carrier | 12 | 12 | 12 | 12 | 12 | 12 | 12 | 12 |
| Additive | 3 | 3 | 3 | 3 | 3 | 3 | 3 | 3 |
| Filler | 33 | 33 | 32 | 32 | 33 | 33 | 33 | 33 |
| Total | 100 | 100 | 100 | 100 | 100 | 100 | 100 | 100 |
| Component B | | | | | | | | |
| Epoxy resin curing agent-1 | 15 | 15 | — | | 15 | 15 | 15 | — |
| Epoxy resin curing agent-2 | — | — | 15 | 15 | — | — | — | 15 |

### Anticorrosive Performance of Epoxy-Based Coating Composition

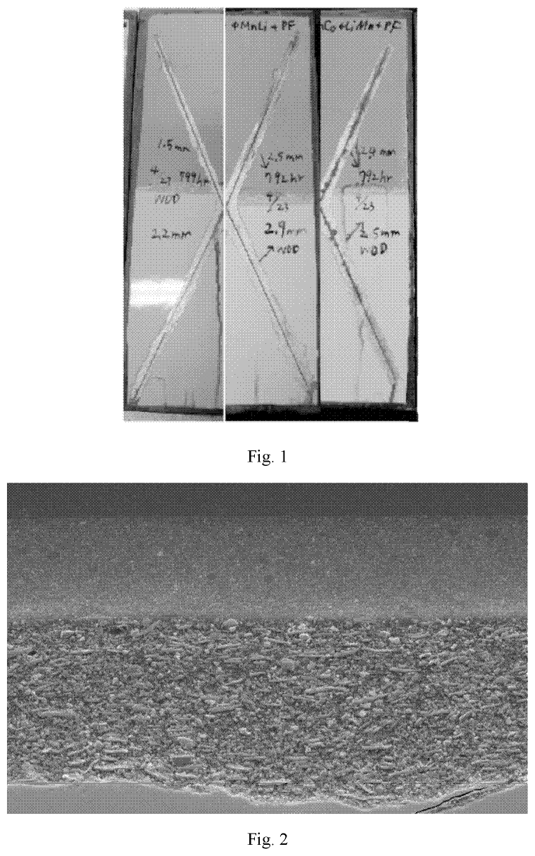

In order to verify the anti-corrosion performance of the epoxy-based chromium-free anticorrosive coating composition containing various lithium-containing composite metal compounds according to the present application, lithium nickel cobalt manganese oxide, lithium manganese, and a 1:1 mixture of the two, were respectively used as anticorrosive pigments and fillers for the epoxy primer systems, as described in Examples 1 to 3. Then, the primer (gray) formed by the coating composition of Examples 1 to 3 and the coat (yellow) formed by coating the above-mentioned basecoat (primer) with a water-based polyurethane topcoat were subjected to the salt spray test according to ASTM B117 for 799 hours, 792 hours and 792 hours, respectively, and their stripping width were determined. The photograph of the coatings after subjecting to the salt spray test was shown in FIG. 1. It can be seen from FIG. 1 that the chromium-free anticorrosive coating composition containing various lithium-containing composite metal compounds according to the present application had a limited stripping width after subjecting to the B117 salt spray test, none of which exceeded 3 mm, and the coating had a smooth surface without blistering and showing an excellent anti-corrosion performance.

In addition, a study of the morphology of the composite coating formed by using the epoxy resin-based chromium-free anticorrosive coating composition of Example 2 as the basecoat (primer) and a water-based polyurethane as the top coat after subjecting to the above-mentioned salt spray test was carried out by scanning electron microscope (SEM). The SEM photograph of FIG. 2 showed a cross-sectional view of the composite coating. It can be seen from FIG. 2 that after subjecting to the salt spray test, the anti-corrosion coating (lower coating) according to the present application had no holes inside and no collapse occurred. It was speculated that this might be due to the fact that the lithium manganese in the coating had a spatially stable crystalline structure.

### Polyaspartate-Based Anticorrosive Coating Composition

As shown in Table 3, the components of Component A were mixed to obtain a mixture, which is then mixed with Component B to form the polyaspartate-based anticorrosive coating composition according to Example 5 of the present application and Comparative Example 5, in which the Example 5 contained lithium nickel cobalt manganese oxide as an anticorrosive pigment/filler, and the Comparative Example 5 did not contain the above lithium nickel cobalt manganese oxide.

TABLE 3
Composition and amount of polyaspartate-
based anticorrosive coating composition

| Raw materials/g | CEx. 5 | Ex. 5 |
|---|---|---|
| Component A | | |
| Polyaspartate | 34 | 34 |
| Lithium Nickel Manganese Cobalt Oxide | — | 6 |
| Carrier | 6 | 6 |
| additive | 1.5 | 1.5 |
| filler | 55 | 49 |
| Total | 100 | 100 |
| Component B | | |
| Polyaspartate curing agent | 23 | 23 |

### Anticorrosive Performance of Polyaspartate-Based Coating Composition

In order to verify the anti-corrosion performance of the polyaspartate-based chromium-free anticorrosive coating composition containing lithium-containing composite metal compounds according to the present application, lithium nickel cobalt manganese oxide was used as an anticorrosive pigment/filler for a polyaspartate primer system, as described in Example 5.

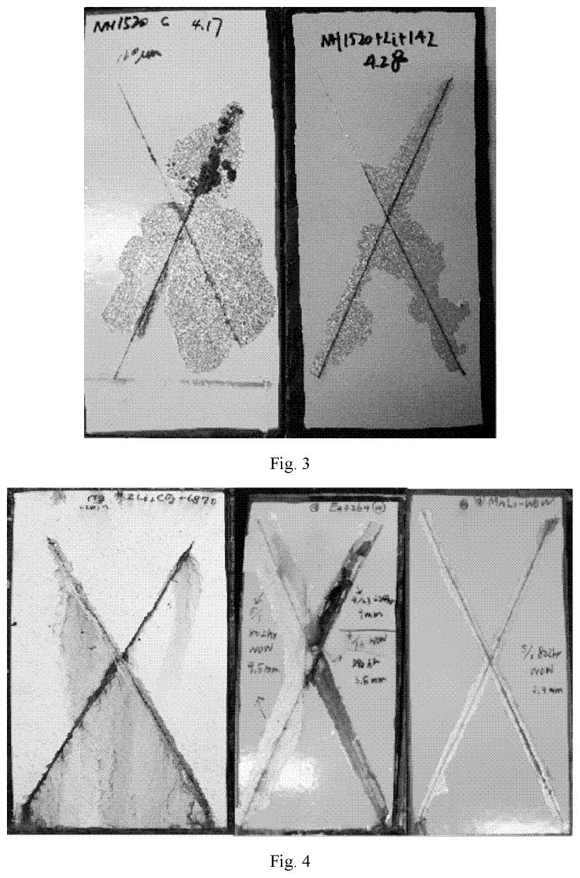

Then, the primer formed from the coating composition of Example 5 was subjected to retort in 5 wt % sodium chloride hot water at 80° C. for 64 hours, and the stripping width was measured. In contrast, the comparative polyaspartate primer without lithium nickel cobalt manganese oxide (Comparative Example 5) was similarly tested. The photographs of each coating after subjecting to retort was shown in FIG. 3.

It can be seen from FIG. 3 that the lithium-containing composite metal compound was also suitable for the polyaspartate system and improved the anti-corrosion performance of the coating. Compared with the coating containing no lithium-containing composite metal compound, the coating containing the lithium-containing composite metal compound had significantly reduced stripping width.

### Comparison of Chromium-Free Anticorrosive Coating Composition of the Present Application and Conventional Anticorrosive Coating Composition

In order to compare the anticorrosive performance of the chromium-free anticorrosive coating composition containing lithium-containing composite metal compound according to the present application and the conventional anticorrosive coating composition, three coatings was applied in a wet-on-wet process and compared with each other in which the coating formed from the lithium manganese oxide-containing chromium-free anticorrosive coating composition according to Example 2 of the present application and the water-based polyurethane topcoat was listed in the right of FIG. 4, the coating formed from the aluminum tripolyphosphate-containing anticorrosive coating composition according to Comparative Example 2 and the same water-based polyurethane topcoat was listed in the middle of FIG. 4, and the coating formed from the lithium carbonate-containing anticorrosive coating composition according to Comparative Example 4 and the same water-based polyurethane topcoat was listed in the left of FIG. 4. FIG. 4 showed the photographs of these three coatings after subjecting to the ASTM B117 salt spray test for about 800 hours.

In addition, it can be seen from FIG. 4 that the coating formed by the lithium-containing composite metal compound chromium-free anticorrosive coating composition according to the present application had limited stripping width, smooth surface, no blistering, and exhibited excellent anticorrosive performance. In contrast, the coating formed from the chromium-free anticorrosive coating composition (Comparative Example 4) formulated with lithium carbonate after subjecting to the above test blistered on the surface, which could not meet the basic requirements of anticorrosive coating. The aluminum tripolyphosphate-containing anticorrosive coating composition exhibited remarkable peeling and low wet adhesion.

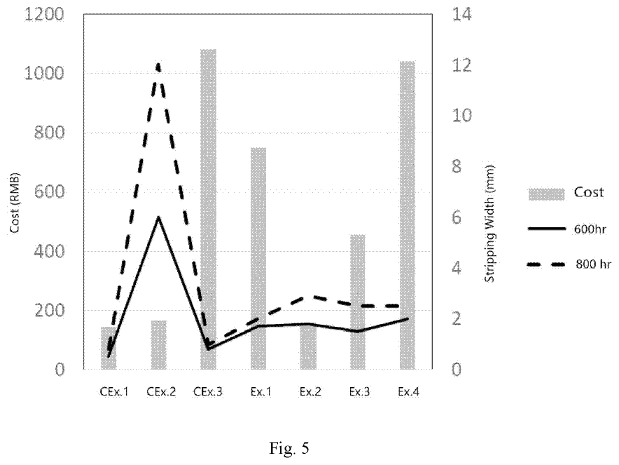

In addition, the inventors compared the chromium-free anticorrosive coating composition containing various lithium-containing composite metal compounds according to the present application with those anticorrosive coating compositions comprising the common chromium-free anticorrosive pigments (such as zinc tripolyphosphate and aluminum molybdate) or the common commercial chromium-containing anticorrosive pigments and fillers (such as strontium chromate) in terms of stripping width and cost. The results were shown in FIG. 5.

It can be seen from the results of FIG. 5 that the chromium-free anticorrosive coating composition containing a lithium-containing composite metal compound according to the present application showed better overall performance in terms of anticorrosion performance and cost, which was relatively close to the overall performance of the chromium-containing anticorrosive coating composition. In contrast, the anti-corrosion performance of aluminum tripolyphosphate was inferior to the lithium-containing composite metal compound according to the present application; and the anti-corrosion performance of zinc molybdate was equivalent to the lithium-containing composite metal compound of the present application, but its cost was significantly higher.

While the present disclosure has been described with respect to a number of embodiments and examples, those skilled in the art, having benefit of this invention, will appreciate that other embodiments can be devised which do not depart from the scope and spirit of the present disclosure as disclosed herein.

1. A chromium-free anticorrosive coating composition, comprising:
Component A, comprising a film-forming resin composition, a lithium-containing composite metal compound, optional carriers and additional additives, wherein the lithium-containing composite metal compound has a spatially stable crystalline structure and comprises at least one transition metal element; and
optionally, Component B, comprising a curing agent.

2. The chromium-free anticorrosive coating composition according to claim 1, wherein the lithium-containing composite metal compound has a layered structure, a spinel structure, an olivine structure or a tunnel structure.

3. The chromium-free anti corrosive coating composition according to claim 1, wherein the transition metal element is one or more selected from nickel, cobalt, manganese, iron and titanium.

4. The chromium-free anti corrosive coating composition according to claim 1, wherein the lithium-containing composite metal compound is one or more selected from the group consisting of lithium manganese oxide, lithium nickel cobalt manganese oxide, lithium cobalt oxide, and lithium iron phosphate.

5. The chromium-free anticorrosive coating composition of claim 1, wherein relative to the total weight of Component A, the lithium-containing composite metal compound is present in an amount of 3 wt % or more, preferably 5 wt % or more, but not more than 15 wt %

6. The chromium-free anticorrosive coating composition according to claim 1, wherein the film-forming resin composition comprises at least one of epoxy resin, chlorinated resin, polyaspartate, alkyd resin, phenolic resin, polyurethane, polysiloxane, polyester resin, and acrylic resin, preferably at least one of epoxy resin, chlorinated resin, and polyaspartate.

7. The chromium-free anticorrosive coating composition according to claim 1, wherein the carrier comprises water, a water-miscible organic solvent, a waterimmiscible organic solvent, or a combination thereof.

8. The chromium-free anticorrosive coating composition according to claim 1, wherein the chromium-free anticorrosive coating composition is an aqueous coating composition.

9. The chromium-free anticorrosive coating composition according to claim 1, wherein the chromium-free anticorrosive coating composition is a solvent-borne coating composition.

10. The chromium-free anticorrosive coating composition according to claim 1, wherein the chromium-free anticorrosive coating composition is a powder coating composition.

11. The chromium-free anticorrosive coating composition according to claim 1, wherein the Component A comprises, relative to the total weight of Component A,
30-70% by weight of the film-forming resin composition;
3-15% by weight of the lithium-containing composite metal compound;
0-15% by weight of the carrier; and
0-65% by weight of the additional additives.

12. The chromium-free anticorrosive coating composition according to claim 1, wherein the chromium-free anticorrosive coating composition is a primer or a direct-to-metal coating.

13. An article comprising
a metal substrate; and
a coating formed of the chromium-free anticorrosive coating composition according to claim 1 which is directly applied to the metal substrate.

14. The article of claim 13, wherein the metal substrate is one or more selected from steel, iron, aluminum, zinc, and alloys thereof.

15. The chromium-free anticorrosive coating composition according to claim 1, wherein the lithium-containing composite metal compound further comprises one or more magnesium salts selected from magnesium oxide, oxyaminophosphate salts of magnesium, magnesium carbonate, magnesium hydroxide, and mixtures thereof.
